(19) United States
(12) Patent Application Publication
(10) Pub. No.: US 2020/0047621 A1
(43) Pub. Date: Feb. 13, 2020

(54) COLLECTED CURRENT MONITORING DEVICE

(71) Applicant: Central Japan Railway Company, Aichi (JP)

(72) Inventors: Kotaro Nakamura, Aichi (JP); Hiroki Shimoyama, Aichi (JP); Shota Mizuno, Aichi (JP); Yoshitsugu Morita, Aichi (JP); Ryota Shinmura, Aichi (JP)

(21) Appl. No.: 16/534,307

(22) Filed: Aug. 7, 2019

(30) Foreign Application Priority Data
Aug. 10, 2018 (JP) 2018151562

(51) Int. Cl. B60L 5/38; B60L 3/12; G01M 17/08

(52) U.S. Cl. CPC B60L 5/38; B60L 2200/26; G01M 17/08; B60L 3/12

(57) ABSTRACT

The present disclosure provides a collected current monitoring device installed on a railroad vehicle comprising a first current collector and a second current collector. The collected current monitoring device comprises a detector that detects a first current flowing to the first current collector and a second current flowing to the second current collector, and a determiner that determines whether it is necessary to control collected current of the railroad vehicle based on the first current and the second current detected by the detector. The determiner determines that it is necessary to control the collected current when a sum of a first non-energized time during which the first current is not flowing and a second non-energized time during which the second current is not flowing in a specified counting time exceeds a threshold value.

### CROSS-REFERENCE TO RELATED APPLICATIONS

The present application claims the benefit of Japanese Patent Application No. 2018-151562 filed on Aug. 10, 2018 with the Japan Patent Office, the entire disclosure of which is incorporated herein by reference.

### BACKGROUND

The present disclosure relates to a collected current monitoring device.

A railroad vehicle comprises multiple current collectors for receiving electric current from an overhead contact line. When there is abnormality such as a frozen or frosted overhead contact line at the time of running of the railroad vehicle, a situation called contact loss occurs in which the current collector is unable to contact the overhead contact line. When the contact loss occurs in the multiple current collectors at the same time, electric arc occurs and the current collectors can erode.

Therefore, a monitoring device has been proposed for detecting a frozen or frosted overhead contact line (see Japanese Unexamined Patent Application Publication No. 2017-93022).

### SUMMARY

In the aforementioned monitoring device, whether the overhead contact line is frozen or frosted is determined by detecting an imbalance between collected currents in two collected current devices. On the basis of the determination of the frozen or frosted overhead contact line, collecting current (i.e., notch) is reduced to control the generation of the electric arc at the railroad vehicle.

However, in the aforementioned monitoring device, as the collected current of each collected current device is reduced by the collected current control, the imbalance between the collected currents is also reduced, so that it becomes difficult to determine abnormality. As a result, hunting can occur in which the collected current control is repeatedly released and implemented, that is, released due to determination that there is no abnormality even though an abnormal state of the overhead contact line continues, and then implemented due to detection of abnormality resulting from an increase in the collected current. Such a defect can also occur in abnormalities in the overhead contact line other than the frozen or frosted overhead contact line.

In one aspect of the present disclosure, it is desirable to provide a collected current monitoring device that enables collected current control corresponding to abnormality in an overhead contact line, regardless of magnitude of collected current.

One aspect of the present disclosure provides a collected current monitoring device installed on a railroad vehicle comprising a first current collector and a second current collector. The collected current monitoring device comprises a detector that detects a first current flowing to the first current collector and a second current flowing to the second current collector, and a determiner that determines whether it is necessary to control collected current of the railroad vehicle based on the first current and the second current detected by the detector. The determiner determines that it is necessary to control the collected current when a sum of a first non-energized time during which the first current is not flowing and a second non-energized time during which the second current is not flowing in a specified counting time exceeds a threshold value.

According to the configuration as such, determination on the collected current control is made using the sum of the time during which electric current is not flowing to the respective current collectors (that is, the first non-energized time and the second non-energized time). As a result, it is possible to implement the collected current control on the abnormality in the overhead contact line while excluding abnormality in the current collectors, such as failure of one of the current collectors, from a subject of the collected current control.

Also, the first non-energized time and the second non-energized time can be measured regardless of the magnitude of the collected current in each current collector. Therefore, the collected current control corresponding to the abnormality in the overhead contact line can be achieved regardless of the magnitude of the collected current.

In one aspect of the present disclosure, the threshold value may be selected in accordance with a running speed of the railroad vehicle. According to the configuration as such, determination accuracy of the collected current control against the abnormality in the overhead contact line can be increased. In other words, since frequency of occurrence of contact loss when the overhead contact line is in a normal state varies in accordance with the running speed of the railroad vehicle, setting the threshold value in accordance with the running speed increases the determination accuracy.

In one aspect of the present disclosure, the threshold value may be selected in accordance with the first current, the second current, or a sum of the first current and the second current. According to the configuration as such, the collected current control is reduced when the collected current is small and arc erosion is unlikely to occur, and the collected current control can be actively performed when the collected current is large. As a result, it is possible to efficiently operate the railroad vehicle while reducing occurrence of the electric arc.

In one aspect of the present disclosure, the determiner may determine that it is necessary to control the collected current when the first non-energized time exceeds a first auxiliary threshold value and the second non-energized time exceeds a second auxiliary threshold value, and a sum of the first non-energized time and the second non-energized time exceeds the threshold value. According to the configuration as such, it is possible to exclude a state in which the non-energized time of one of the first current collector and the second current collector is small from the subject of the collected current control.

In one aspect of the present disclosure, the counting time may be equal to or more than a time obtained by dividing a distance between the first current collector and the second current collector in a running direction of the railroad vehicle by the running speed of the railroad vehicle. According to the configuration as such, since the first current collector and the second current collector can pass through the same abnormal portion of the overhead contact line in the counting time, the determination accuracy can be increased.

### BRIEF DESCRIPTION OF THE DRAWINGS

An example embodiment of the present disclosure will be described hereinafter with reference to the accompanying drawings, in which:

FIG. 1 is a block diagram schematically showing a configuration of a train and a collected current monitoring device according to an embodiment;

FIG. 2 is a graph illustrating a relationship between a threshold value used by a determiner in FIG. 1 and a running speed of the train;

FIG. 3 is a graph illustrating a relationship between the threshold value used by the determiner in FIG. 1 and a collected current;

FIG. 4 is a graph illustrating the threshold value used by the determiner in FIG. 1 and auxiliary threshold values; and

FIG. 5 is a flow diagram schematically showing a process executed by the determiner in FIG. 1.

### DETAILED DESCRIPTION OF THE PREFERRED EMBODIMENTS

### 1. First Embodiment

### [1-1. Configuration]

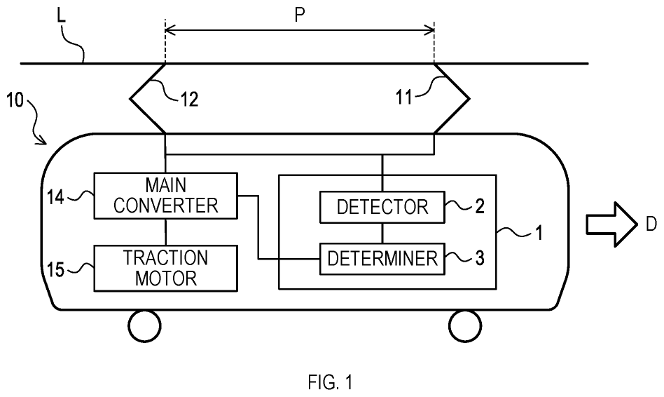

A train 10 shown in FIG. 1 comprises a first current collector 11, a second current collector 12, a main traction converter 14, a traction motor 15, and a collected current monitoring device 1.

The train 10 transmits electric power supplied from an overhead contact line L via the first current collector 11 and the second current collector 12 mounted on a roof of a vehicle body to the main traction converter 14, and drives the traction motor 15 to run. The main traction converter 14 and the traction motor 15 are provided in each vehicle constituting the train 10.

The collected current monitoring device 1 provided in each train 10 is configured to detect abnormality such as the frozen or frosted overhead contact line L and control collected current of the train 10. The collected current monitoring device 1 comprises a detector 2 and a determiner 3.

<Detector>

The detector 2 detects a first current I1 flowing to the first current collector 11, and a second current I2 flowing to the second current collector 12.

The detector 2 transmits a value of the first current I1 and a value of the second current I2 to the determiner 3. A current value of each current collector is obtained at predetermined intervals (that is, sampling time).

<Determiner>

The determiner 3 determines whether it is necessary to control a running speed V of the train 10, that is, to control the collected current, based on the first current I1 and the second current I2 detected by the detector 2.

Specifically, the determiner 3 determines that it is necessary to control the collected current (that is, to control the collected current to a specified value or less) when a sum T3 of a first non-energized time T1 during which the first current I1 is not flowing and a second non-energized time T2 during which the second current I2 is not flowing in a specified counting time exceeds a threshold value S0, and then transmits a collected current control signal based on notch control to the main traction converter 14.

The first non-energized time T1 and the second non-energized time T2 are counted at the same counting time. Each of the first non-energized time T1 and the second non-energized time T2 means a total time during which electric current is not flowing in the counting time.

The counting time in which the first non-energized time T1 and the second non-energized time T2 are counted can be freely defined. The counting time can be defined, for example, as a time during which the train 10 runs a specified distance. However, since the sampling time exists in detection of the current value of each current collector as above, it is preferable to define the counting time based on a specified rule.

Specifically, it is preferable that the counting time is equal to or more than a time obtained by dividing a distance P between the first current collector 11 and the second current collector 12 in a running direction D of the train 10 by the running speed V of the train 10. Since the first current collector 11 and the second current collector 12 can pass through the same abnormal portion of the overhead contact line L in the counting time, determination accuracy can be increased. The distance P indicates a distance between a point of contact of the first current collector 11 with the overhead contact line L and a point of contact of the second current collector 12 with the overhead contact line L.

When the counting time is too long, a time to determine abnormality becomes long, and start of the collected current control is delayed. Therefore, it is preferable that an upper limit of the counting time is a drum pitch of the overhead contact line. Further, it is more preferable that the counting time is a minimum time that is equal to or more than the time obtained by dividing the distance P by the running speed V of the train 10 and that is a multiple of the sampling time of the detector 2.

Instead of the first non-energized time T1 and the second non-energized time T2, a time rate obtained by dividing each of the first non-energized time T1 and the second non-energized time T2 by the counting time may be used to make the above determination. In this case, the threshold value S0 does not have a time dimension and is dimensionless.

The threshold value S0 is a predetermined value. The threshold value S0 may be a constant number which is independent of state parameters such as the running speed and the like of the train 10, or may be a function or a table of which value changes in accordance with the state parameters.

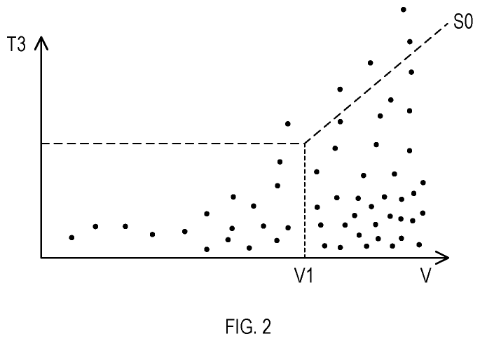

For example, the threshold value S0 may be a function or a table of which value is selected in accordance with the running speed V of the train 10. FIG. 2 shows an example relationship between the running speed V and the threshold value S0. Generally, as the running speed V increases, the running speed V approaches a wave propagation speed of the overhead contact line L. As a result, vibration due to contact of the current collector 11, 12 with the overhead contact line L becomes difficult to attenuate, and tracking performance of the current collector 11, 12 to the overhead contact line L is reduced. Therefore, frequency of occurrence of the contact loss in a normal state of the overhead contact line L increases. Multiple dots in FIG. 2 indicate example measurement results of the sum T3 of the first non-energized time T1 and the second non-energized time T2.

Setting the threshold value S0 such that the larger the running speed V is, the larger the threshold value S0 is can reduce erroneous determination when the running speed V is large. Setting the threshold value S0 in accordance with the running speed V as such increases the determination accuracy. The threshold value S0 is constant in an area where the running speed V in FIG. 2 is equal to or lower than V1. In an area where the running speed V in FIG. 2 exceeds V1, the threshold value S0 linearly increases in accordance with an increase of the running speed V.

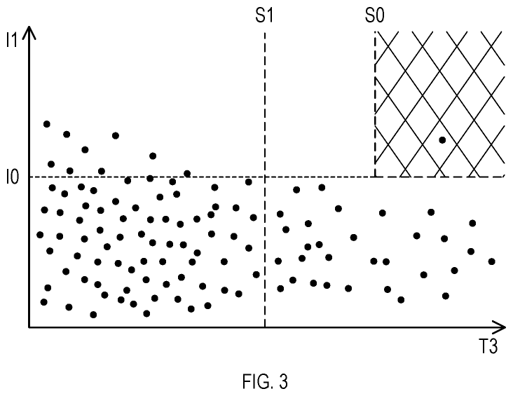

The threshold value S0 may be a function or a table of which value is selected in accordance with the first current I1, the second current I2, or a sum I3 of the first current I1 and the second current I2. FIG. 3 is an example relationship between the first current I1 and the threshold value S0.

In a state in which the first current I1 or the second current I2 is small, electric arc is unlikely to occur, so necessity to control the collected current is low. Thus, in the state in which the first current I1 or the second current I2 is small, the threshold value S0 is increased so as to avoid unnecessary control of the collected current, while in a state in which the first current I1 and the second current I2 are large, the threshold value S0 is reduced so as to actively control the collected current. Then, efficient running of the train is achieved.

In FIG. 3, in an area where the first current I1 is equal to or smaller than I0, the threshold value S0 is infinite, that is, there is no threshold value S0. On the other hand, in an area where the first current I1 exceeds I0, the threshold value S0 is constant. In other words, a shaded area in FIG. 3 is a collected current control area.

Also, in FIG. 3, a secondary threshold value S1 is provided in addition to the threshold value S0. The secondary threshold value S1 is provided to make a determination to maintain the collected current control after the sum T3 of the first non-energized time T1 and the second non-energized time T2 exceeds the threshold value S0 and the collected current is controlled. In other words, an area larger than the secondary threshold value S1 in FIG. 3 (that is, a right side area of the secondary threshold value S1) is an area to maintain the collected current control.

As such, the determiner 3 continues to determine that it is necessary to control the collected current after the sum T3 of the first non-energized time T1 and the second non-energized time T2 exceeds the threshold value S0 until the sum T3 is equal to or smaller than the secondary threshold value S1. In other words, the determiner 3 outputs a release signal for the collected current control to the main traction converter 14 when the sum T3 is equal to or smaller than the secondary threshold value S1. The secondary threshold value S1 is a constant value in FIG. 3, but may vary in accordance with state parameters.

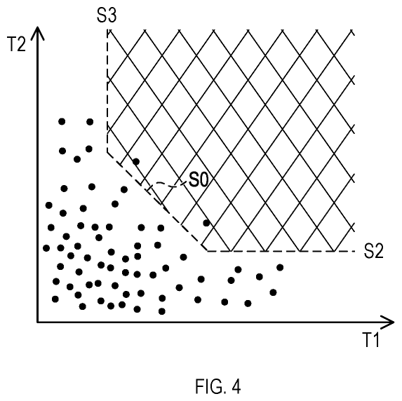

Further, as shown in FIG. 4, the determiner 3 may use a first auxiliary threshold value S2 and a second auxiliary threshold value S3, in addition to the threshold value S0, for the determination. Specifically, the determiner 3 determines that it is necessary to control the collected current when the first non-energized time T1 and the second non-energized time T2 respectively exceed the first auxiliary threshold value S2 and the second auxiliary threshold value S3, and the sum T3 of the first non-energized time T1 and the second non-energized time T2 exceeds the threshold value S0. As a result, it is possible to exclude the state in which the non-energized time of one of the first current collector 11 and the second current collector 12 is small from a subject of the collected current control.

In FIG. 4, a shaded area surrounded by a line segment representing the threshold value S0, a half-line representing the first auxiliary threshold value S2, and a half-line representing the second auxiliary threshold value S3 is the collected current control area. The first auxiliary threshold value S2 and the second auxiliary threshold value S3 may vary in accordance with the state parameters.

Also, in the running train 10, contact loss is likely to occur in the second current collector 12 located rearward in the running direction D, rather than the first current collector 11 located forward in the running direction D. Therefore, it is preferable to make the second auxiliary threshold value S3 larger than the first auxiliary threshold value S2.

[1-2. Processing]

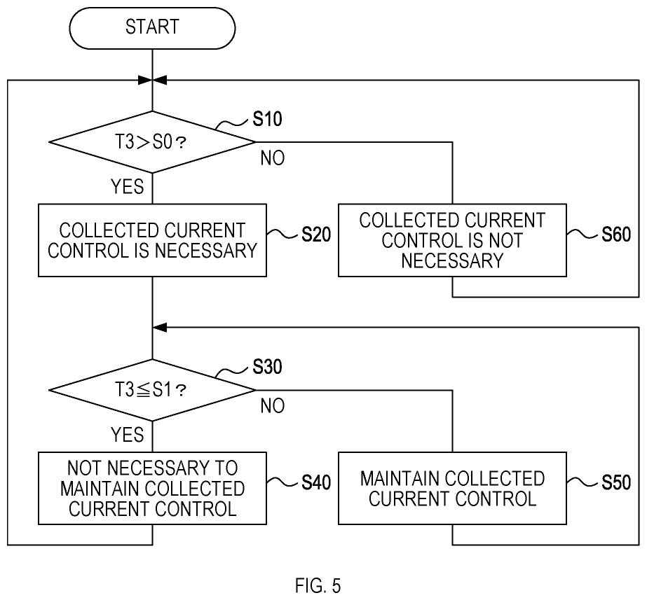

Referring to a flow diagram in FIG. 5, a collected current control determination process executed by the determiner 3 will be described hereinafter.

First, the determiner 3 determines whether the sum T3 of the first non-energized time T1 and the second non-energized time T2 exceeds the threshold value S0 (Step S10). When there are the auxiliary threshold values S2 and S3 as in FIG. 4, it is also determined whether the first non-energized time T1 and the second non-energized time T2 exceed the auxiliary threshold values S2 and S3, respectively.

When the sum T3 exceeds the threshold value S0 (S10: YES), the determiner 3 determines that it is necessary to control the collected current (Step S20), and transmits a collected current control signal to the main traction converter 14. When the auxiliary threshold values are set, the process proceeds to Step S20 only when all the parameters exceed the threshold value or the auxiliary threshold values.

When it is determined that it is necessary to control the collected current, the determiner 3 determines whether the current sum T3 is still equal to or smaller than the secondary threshold value S1 (Step S30). When the sum T3 is equal to or smaller than the secondary threshold value S1 (S30: YES), the determiner 3 determines that it is not necessary to maintain the collected current control (Step S40), transmits the release signal for the collected current control to the main traction converter 14, and then repeats the present process from Step S10.

On the other hand, when the sum T3 exceeds the secondary threshold value S1 (S30: NO), the determiner 3 determines that it is necessary to maintain the collected current control (Step S50), and repeats Step S30 until the sum T3 is equal to or smaller than the secondary threshold value S1.

In Step S10, when the sum T3 is equal to or smaller than the threshold value S0 (S10: NO), the determiner 3 determines that it is not necessary to control the collected current (Step S60), and repeats the present process from Step S10.

When the secondary threshold value S1 is not set in the determiner 3, it is possible to omit Steps S30, S40 and S50. In this case, the determiner 3 transmits the release signal for the collected current control to the main traction converter 14, for example, when a specified time elapses after the collected current is controlled, when it is determined in Step S10 that the sum T3 is equal to or smaller than the threshold value S0, or the like.

[1-3. Effect]

According to the above-detailed embodiment, the following effect can be obtained.

(1a) Determination on the collected current control is made using the sum T3 of the time during which electric current is not flowing to the respective current collectors (that is, the first non-energized time T1 and the second non-energized time T2). Therefore, it is possible to control the collected current on the abnormality in the overhead contact line L while excluding abnormality in the current collectors, such as failure of one of the current collectors, from the subject of the collected current control.

(1b) The first non-energized time T1 and the second non-energized time T2 can be measured regardless of the magnitude of the collected current in each current collector. Therefore, the collected current control corresponding to the abnormality in the overhead contact line can be implemented regardless of the magnitude of the collected current.

### 2. Other Embodiments

The embodiment of the present disclosure has been described above. However, the present disclosure is not limited to the above-described embodiment and can be modified variously.

(2a) A function achieved by one element in the aforementioned embodiment may be divided into two or more elements. A function achieved by two or more elements may be integrated into one element. Further, a part of the configuration of the aforementioned embodiment may be omitted. At least a part of the configuration of the aforementioned embodiment may be added to or replaced with a configuration of another embodiment. It should be noted that any and all modes that are encompassed in the technical ideas defined by the languages in the scope of the claims are embodiments of the present disclosure.

1. A collected current monitoring device installed on a railroad vehicle comprising a first current collector and a second current collector, the collected current monitoring device comprising:
a detector that detects a first current flowing to the first current collector and a second current flowing to the second current collector; and
a determiner that determines whether it is necessary to control collected current of the railroad vehicle based on the first current and the second current detected by the detector,
the determiner determining that it is necessary to control the collected current when a sum of a first non-energized time during which the first current is not flowing and a second non-energized time during which the second current is not flowing in a specified counting time exceeds a threshold value.

2. The collected current monitoring device according to claim 1, wherein
the threshold value is selected in accordance with a running speed of the railroad vehicle.

3. The collected current monitoring device according to claim 1, wherein
the threshold value is selected in accordance with the first current, the second current, or a sum of the first current and the second current.

4. The collected current monitoring device according to claim 1, wherein
the determiner determines that it is necessary to control the collected current when the first non-energized time exceeds a first auxiliary threshold value and the second non-energized time exceeds a second auxiliary threshold value, and a sum of the first non-energized time and the second non-energized time exceeds the threshold value.

5. The collected current monitoring device according to claim 1, wherein
the counting time is equal to or more than a time obtained by dividing a distance between the first current collector and the second current collector in a running direction of the railroad vehicle by the running speed of the railroad vehicle.
